(19) United States
(12) Patent Application Publication
(10) Pub. No.: US 2005/0123833 A1
(43) Pub. Date: Jun. 9, 2005

(54) Separator for electrochemical cells

(76) Inventors: Mark A. Schubert, Brunswick, OH (US); John P. Myers, Brooklyn, OH (US)

Correspondence Address: ROBERT W WELSH;EVEREADY BATTERY COMPANY INC, 25225 DETROIT ROAD, P O BOX 450777, WESTLAKE, OH, 44145, US

(21) Appl. No.: 10/866,887

(22) Filed: Jun. 14, 2004

Related U.S. Application Data
(63) Continuation-in-part of application No. 10/480,073, filed on Dec. 8, 2003.

(51) Int. Cl. H01M 2/16; H01M 10/26; H01M 4/50; H01M 4/42; H01M 4/54; H01M 2/12

(52) U.S. Cl. 429/249; 429/219; 429/224; 429/229; 429/206; 429/82

(57) ABSTRACT

A copolymer of an ethylenically unsaturated carboxylic acid, e.g. acrylic or methacrylic acid, and an aromatic sulphonate or carboxylate, e.g. sodium styrenesulphonate, either alone or supported on a substrate, may be used as a separator for an electrochemical cell such as a silver-zinc cell or a zinc-air cell.

### CROSS-REFERENCE TO A RELATED APPLICATION

This application is a continuation-in-part of prior application Ser. No. 10/480,073, filed Dec. 8, 2003.

The present invention relates to a novel separator for use in electrochemical cells.

Many constructions of electrochemical cells require a separator to prevent physical and electrical contact between the cathode and anode, while permitting ionic transfer. Moreover, it is necessary that the separator should prevent growth of zinc oxide deposits (dendrites) which could lead to shorting and thus abrupt and premature failure of the cell. This problem is particularly acute in rechargeable cells that incorporate a zinc electrode, such as rechargeable zinc-air cells and rechargeable zinc-silver cells. In cylindrical cells, materials commonly referred to as ‘paper’ are normally used to make such separators. Although many attempts have been made to modify the papers used, none is perfect for all applications. Indeed, it is only in recent years that there has been any understanding that the nature and construction of the separator can have a significant effect on the performance of the electrochemical cell.

Moreover, standard electrochemical cells have to fit, within a very small tolerance, internationally agreed dimensions. Thus, the volume available within these cells is strictly limited. Hence, any volume occupied by inactive materials (such as the separator) is volume that cannot be occupied by active materials, and so the performance of the cell suffers. It is therefore desirable to minimize the volume in the cell occupied by the separator. Separators are typically paper sheets or cellophane films disposed between the electrodes. In order to maximise battery capacity, the paper and cellophane separators are already about as thin as they can be without being too fragile to allow handling and installation of the separator in the battery assembly. Also, thinner paper separators will result in shorting between the electrodes because of the porosity of the fibrous structure. Indeed, in almost all cases, especially in the more popular consumer cells, it is standard practice to use at least a double layer of separator paper in order to provide the required resistance to penetration of the separator by dendrites.

Thus, it is difficult to produce a separator which is thinner than those conventionally used, but which also meets these other requirements.

We have now discovered that a certain class of copolymers, either alone, or supported on another separator material, can be used, with advantage, as the separator in an electrochemical cell.

Thus, the present invention provides an electrochemical cell comprising an anode and a cathode separated by a separator which is electrically insulating but ionically conducting, said separator comprises:
a copolymer of (1) an ethylenically unsaturated carboxylic acid of formula (I) or salt thereof; 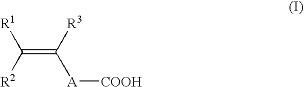
and (2) an aromatic compound of formula (II); 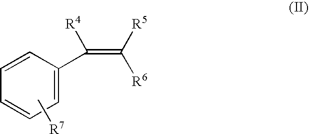
   wherein R¹, R², R³, R⁴, R⁵, and R⁶ are selected from the group consisting of a hydrogen atom, an alkyl group having from 1 to 10 carbon atoms and an aryl group; R⁷ is selected from the group consisting of a sulphonate group, a carboxylate group and an associated balancing cation; and A is selected from the group consisting of a direct bond and an alkyl group having up to 8 carbon atoms.

The copolymer may be used by itself as a separator, in which case it is preferably used to form the separator in situ in the cell, or it may be used as a coating on a porous substrate (for example traditional separator paper), in which case it can allow thinner paper and/or fewer layers to be used.

The invention thus also provides a process for assembling an electrochemical cell in which: an anode or a cathode is inserted into a battery housing; a separator is formed on said anode or cathode by applying, e.g. by spraying, a solution or dispersion of a copolymer of an acid of formula (I) or salt thereof and an aromatic compound of formula (II) thereon and depositing the copolymer from the solution or dispersion; and completing the electrochemical cell.

The invention further provides an electrochemical cell comprising an anode and a cathode separated by a separator comprising a porous substrate having a coating of a copolymer of an acid of formula (I) or salt thereof and an aromatic compound of formula (II).

The invention still further provides a process for assembling an electrochemical cell in which there are inserted into a battery housing an anode, a cathode and a separator comprising a porous substrate supporting a coating of a copolymer of an acid of formula (I) or salt thereof and an aromatic compound of formula (II) located between the anode and the cathode and completing the cell.

The invention further provides an electrochemical cell comprising an anode and a cathode separated by a separator comprising a film of a copolymer of an acid of formula (I) or salt thereof and an aromatic compound of formula (II).

The invention still further provides a process for assembling an electrochemical cell in which there are inserted into a battery housing an anode, a cathode and a separator comprising a film of a copolymer of an acid of formula (I) or salt thereof and an aromatic compound of formula (II) located between the anode and the cathode and completing the cell.

In compounds of formula I and formula II, where R¹, R², R³, R⁴, R⁵ or R⁶ represent an alkyl group, this may be a straight or branched chain group having from 1 to 10 carbon atoms, and examples include the methyl, ethyl, propyl, isopropyl, butyl, isobutyl, sec-butyl, t-butyl, pentyl, isopentyl, neopentyl, hexyl, isohexyl, heptyl, octyl, 2-ethylhexyl, nonyl and decyl groups, of which those groups having from 1 to 6 carbon atoms are preferred, the methyl and ethyl groups being more preferred and the methyl group being most preferred. However, we particularly prefer that R¹, R², R³, R⁴, R⁵ and R⁶ should all represent hydrogen atoms.

Where A represents an alkyl group, this may be a straight or branched chain group having from 1 to 8 carbon atoms, and examples include the methyl, ethyl, propyl, trimethyl, tetramethyl, pentamethyl, hexamethyl, heptamethyl and octamethyl groups. However, A should preferably be a direct bond, i.e. compounds of formula (Ia): 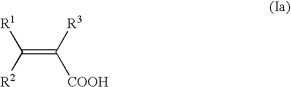
and especially such compounds where R¹, R² and R³ all represent hydrogen atoms.

Specific examples of the unsaturated acid that may be represented by formula (I) or (Ia) include: acrylic acid, methacrylic acid, crotonic acid, isocrotonic acid, 2-, 3- and 4-pentenoic acid, 2-, 3-, 4- and 5-hexenoic acid, the heptenoic acids, the octenoic acids, the nonenoic acids, the decenoic acids, the undecenoic acids, the dodecenoic acids, the tridecenoic acids, the tetradecenoic acids, the pentadecenoic acids, the hexadecenoic acids, the heptadecenoic acids, the octadecenoic acids (especially oleic acid), the nonadecenoic acids and the icosenoic acids. Of these, the lower acids having from 3 to 6 carbon atoms are preferred, acrylic acid and methacrylic acid being most preferred. Esters of these acids are not preferred for use in alkaline cells as they can hydrolyze back to the acid form and are more hydrophobic than the acid. The longer the ester side chain, the more hydrophobic and less ionically conductive the separator will be.

With regard to salts, monovalent cations are preferred. Examples of suitable salts include: the alkali metal salts, such as the sodium and potassium salts; and ammonium salts.

In the aromatic compounds of formula (II), we prefer that R⁴ should be a hydrogen atom or a methyl group, and that one of R⁵ and R⁶ should be a hydrogen atom and the other should be a hydrogen atom or an alkyl group having from 1 to 4 carbon atoms, preferably a methyl group. Most preferably, all of R⁴, R⁵ and R⁶ represent hydrogen atoms.

R⁷ can be a sulphonate or carboxylate group and the associated balancing cation. Preferably, R⁷ is a sulphonate group. There is no particular restriction on the nature of the balancing cation, and examples include: hydrogen atoms, and alkali metal atoms, such as sodium, potassium or lithium.

The position of the unsaturated group, —CR⁴═CR⁵R⁶, relative to the sulphonate or carboxylate group R⁷ is not critical. However, because of convenient availability of such compounds, they be para to each other.

A particularly preferred class of copolymers for use in the present invention are copolymers of an acid of formula (I) and a sulphonate of formula (II) (i.e. R⁷ represents a sulphonate group). More preferred are copolymers of acrylic or methacrylic acid and a styrenesulphonate and most preferred is a copolymer of acrylic acid and a styrenesulphonate. Most preferred is a copolymer of acrylic acid and sodium styrenesulphonate.

The relative proportions of the monomers used to manufacture the copolymer used in the present invention may vary over a wide range. For example, the molar proportion of the compound or compounds of formula (I) to the compound or compounds of formula (II) may vary from 20:80 to 80:20. However, these proportions do have an effect on the properties of the copolymer and its behaviour as the separator in an alkaline electrochemical cell of the present invention. In general, increasing the proportion of the compound of formula (I) in the copolymer simultaneously increases the ionic conductivity of the copolymer, which is desirable, while also increasing the solubility of the copolymer in the cell's electrolyte, which is undesirable. Increasing the proportion of the compound of formula (II) in the copolymer improves the stability of the copolymer in the cell's electrolyte, which is desirable, while also decreasing the conductivity of the copolymer, which is undesirable. Consequently, the ratio of compound(s) of formula (I) to the compound(s) of formula (II) incorporated into the copolymer must be selected to strike a balance between the desired physical stability and ionic conductivity of the copolymer. While a molar ratio (formula (I):formula (II)) of from 20:80 to 80:20 is feasible for some cells, a ratio of 20:80 to 40:60 is preferred. The exact ratio selected is influenced by factors such as processing parameters or environmental conditions to which the polymer will be exposed. Ratios of 20:80, 30:70 and 40:60 are preferred.

The copolymers employed in the present invention may be prepared by thermally initiated free radical solution polymerization which is a well-known technique that does not form part of the present invention.

Where the copolymer alone is to be used as a separator, it is preferably sprayed as a solution or dispersion in situ in the cell. Thus, the cell is partially assembled by inserting one of the electrodes, either the anode or the cathode, into the cell housing and then applying, e.g. by spraying, the solution or dispersion of the copolymer onto that anode or cathode. The solution or dispersion is allowed to dry. Then the other electrode is inserted into the cell and the cell is completed.

The solvent or dispersant used is not critical, although it should be capable of dissolving or dispersing the copolymer and should not harm the anode or cathode or other components of the cell with which it may come into contact. Moreover, it is preferred that it should be relatively easy to remove, e.g. by evaporation, and it is also preferred that it should not be environmentally harmful or harmful to the health of workers who may come into contact with it. Examples of suitable solvents or dispersants include: water and mixtures of water and an alcohol, for example methanol or ethanol.

Alternatively, a solution or dispersion of the polymer can be formed into a film on a suitable non-absorbent substrate, e.g. glass, and the solvent or dispersant removed, e.g. by evaporation, to leave a film of the polymer. This may then, for example, be wound on a mandrel to form a tube, which can then be inserted into a cell housing for use as the substrate.

As a further alternative, the copolymer may be deposited from the solution or dispersion by coagulation by adding a non-solvent to the copolymer. In a battery environment, where it is important to minimize the presence of unnecessary materials, it is preferred to use as the non-solvent a material that would naturally be present in the electrochemical cell. In this case, the preferred non-solvent is an aqueous solution of an alkali metal, preferably potassium or sodium, but most preferably potassium, hydroxide. The concentration of alkali metal hydroxide is preferably from 34% to 42% (w/w solution), more preferably from 35% to 37% (w/w solution) and most preferably about 36% (w/w solution). In particular, it is preferred that the total amount of the alkali metal hydroxide solution used should be in accordance with the guidance given in GB 2,363,899, so that the amount of electrolyte is such that, at a calculated level of one electron discharge of the manganese dioxide, the calculated concentration of potassium hydroxide is between 49.5 and 51.5% (w/w solution).

The amount of copolymer applied should be at least sufficient to provide an unbroken or mainly unbroken film which is resistant to penetration by growing crystals of zinc oxide. Provided that the film is resistant to penetration by growing crystals of zinc oxide and to shorting, small, infrequent blemishes, such as holes or cracks, can be tolerated. In order to achieve this, we prefer that the amount used should be from 10 to 60 gsm (grams per square meter), more preferably from 20 to 50 gsm and most preferably from 30 to 40 gsm.

Alternatively, the copolymer may be supported on a porous substrate of the type commonly used as a separator in electrochemical cell technology. The substrate is typically strip shaped and has a first surface and a second surface. The separator can be positioned so that its first surface contacts the first electrode (cathode) and its second surface contacts the second electrode (anode). The coating may be applied to one or both sides, or it may be soaked into the substrate. In either case, it is applied as a solution or dispersion and then dried (by removal of solvent, e.g. by evaporation) or coagulated as described above. As above, it is preferred that the amount is from 10 to 60 gsm, more preferably from 20 to 50 gsm and most preferably from 30 to 40 gsm.

A preferred process for producing a separator useful in a cell of this invention is to use a technique known as transfer lamination wherein the polymer is dispensed through a slot or via a reverse roll coater onto a first transfer film, then solidifying and laminating the exposed side of the polymer layer to one side of a strip shaped substrate and then removing the transfer film from the polymer layer while the polymer layer remains attached to the substrate. The net result is a separator having a substrate with a thin layer of the polymer secured to one side. Preferably, a second polymer layer is formed on a second transfer film and the second polymer layer is then laminated to the uncoated side of the substrate. In this case, the net result is a separator wherein the substrate is sandwiched between two polymer layers. The transfer lamination process is preferred because the polymer layer is solidified before the polymer contacts the surface of the substrate thereby enabling the polymer layer to form as a continuous layer that is essentially free of pin holes or other physical imperfections. In contrast, coating a surface of the substrate directly with an aqueous solution of the polymer results in the polymer flowing into the substrate's porous, fibrous surface and possibly allowing small openings to form in the polymer layer. These openings are undesirable as they could allow an electrical short to develop within the cell thereby reducing the useful life of the cell. To compensate for the formation of the openings, the quantity of polymer in the aqueous solution must be greater than the quantity of polymer needed if a polymer layer is formed as described above. As the quantity of polymer disposed on the separator is increased, the ionic resistance of the separator also increases and the service performance of the cell will be reduced.

The concentration of copolymer in the solution or dispersion used will affect the viscosity of that solution or dispersion. We prefer that the viscosity should be in the range from 10 to 50 Pa*s, more preferably from 15 to 35 Pa*s and most preferably from 20 to 25 Pa*s. At viscosities in these ranges, the copolymer solution or dispersion is sufficiently thick to be coated effectively using a standard roller coating method, and so the copolymer may be applied, using such a method, to one or both sides of the substrate. At lower viscosities, the solution or dispersion is preferably allowed to soak into the substrate. The preferred viscosities may be achieved, when the solvent is water, by forming a solution having a solids content of from 20 to 45%, more preferably from 25 to 35% and most preferably about 30%.

The amount of the copolymer applied to the substrate may vary over a wide range, but we prefer to apply an amount of from 20 to 60 gsm (grams per square meter), whether this is applied as one layer on one side of the substrate, as two layers on each side of the substrate or by soaking, so that the copolymer extends through the substrate. Where the coating is applied as a single coat on one side, at 20 gsm, visual inspection shows the coating to appear thin; at a coating weight of about 40 gsm, on visual inspection, the coating appears thick and heavy. Moreover, we have found that the service performance (i.e. run time) of an electrochemical cell incorporating the coated separator of the present invention decreases as the coating weight increases. On the other hand, the coating needs to be sufficiently thick to achieve the objective of preventing internal shorting in the electrochemical cell. A balance must be struck between these two factors, and the point at which the balance is struck will vary depending on the size and intended use of the electrochemical cell. Simple experimentation, following the guidelines in the subsequent examples, will allow a person skilled in the art to determine where to strike the balance for any particular application. More preferably the amount of copolymer applied is from 20 to 50 gsm and most preferably from 30 to 40 gsm.

The apparatus used for coating may be any conventional coating apparatus, and many forms of such apparatus are available commercially. The apparatus used herein was a Dixon Pilot Coater, manufactured by T.H. Dixon & Co. Ltd., Letchworth, Herts, England, and this, or equivalent full-scale apparatus, may be used in practising the present invention.

The material chosen for the substrate has to meet certain specific requirements: it must be ionically conductive but electrically insulating. It must also be stable under both oxidising and reducing conditions in a strongly alkaline environment. Ideally, it should also be strong and flexible and should be capable of rapidly absorbing electrolyte. Such materials are well known to the person skilled in the manufacture of electrochemical cells. They may be woven or non-woven, cast, or bonded.

A great variety of separator materials, which may be used as the substrate, are available and well known in the art. The particular one of these chosen for use in the present invention is not critical, and any conventional separator material may be employed as the substrate. Examples of suitable materials include the mixtures of polyvinyl alcohol (vinylon), and mercerised hardwood fiber sold as VLZ75 and VLZ105 (respectively about 75 and 105 μm thick) by Nippon Kodoshi Corporation (NKK), the similar material sold as by Hollingsworth and Vose and the mixture of lyocell rayon fiber, polyvinyl alcohol fiber, matrix fiber and binder fiber sold by Freudenberg.

Where the copolymer solution or dispersion is to be dried, other than in the electrochemical cell, this is preferably by steam drum drying. Other forms of drying are possible.

The other components of electrochemical cells are well known and are described, for example, in ‘Handbook of Batteries’ Second Edition by David Linden, published by McGraw-Hill, 1995, the disclosures of which are incorporated herein by reference.

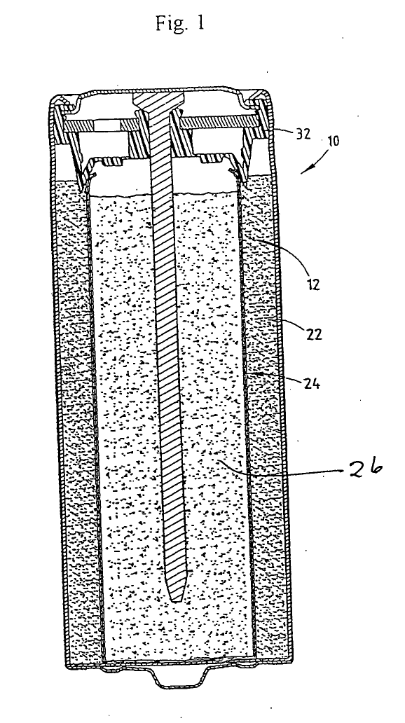

As shown in FIG. 1, an alkaline manganese cell 10 comprises an anode 26 and a cathode 12 separated by the separator 24 of the present invention, and contained within a can 22, sealed with an appropriate seal 32. In addition, there will be an electrolyte, normally an aqueous solution of an alkali, e.g. an alkali metal hydroxide, such as potassium hydroxide, in a concentration that is at least 30 weight percent, more preferably from 33 to 42 weight percent. The amount of potassium hydroxide will preferably be such as to give a final potassium hydroxide concentration after discharge of the cell to the one electron level of from 50 to 51%, most preferably about 50.6%.

The anode may be in the form of a paste containing as the main active component zinc. In addition, it will generally contain a proportion of the electrolyte, normally an aqueous solution of potassium hydroxide, to form a paste. A thickening agent, such as a carbomer, for example Carbopol 940™, and other ingredients, such as zinc oxide and/or a gassing inhibitor, e.g. indium hydroxide, may also be included, if desired, as is well known in the art. Carbopol 940™ is available from Noveon, Cleveland, Ohio U.S.A.

The cathode will, in the case of an alkaline manganese cell, contain manganese dioxide (MnO₂) as its main ingredient. The MnO₂ is, as is conventional, wholly or mainly electrochemical MnO₂ (EMD), although some chemical MnO₂ (CMD) may be included if desired for particular purposes. In addition, it is often necessary to incorporate a conductive material in order to improve electronic conduction within the cathode, and the preferred conductive material is graphite. Finally, it is preferred to pre-mix the materials forming the cathode with a proportion of the electrolyte, generally an aqueous solution of potassium hydroxide.

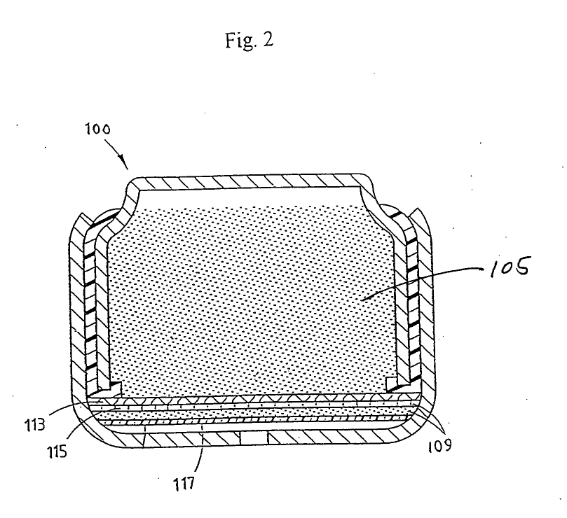

Cell constructions other than the elongated cylindrical cell construction shown in FIG. 1 can utilize a separator as described herein. For example, a miniature zinc-air cell 100, as shown in FIG. 2, can readily incorporate a separator that includes a layer of the copolymer of the compounds of formula (I) and formula (II). Separator 113 is located between anode 105 and cathode 109 which includes a nickel screen 115 and a positive electrode mix 117.

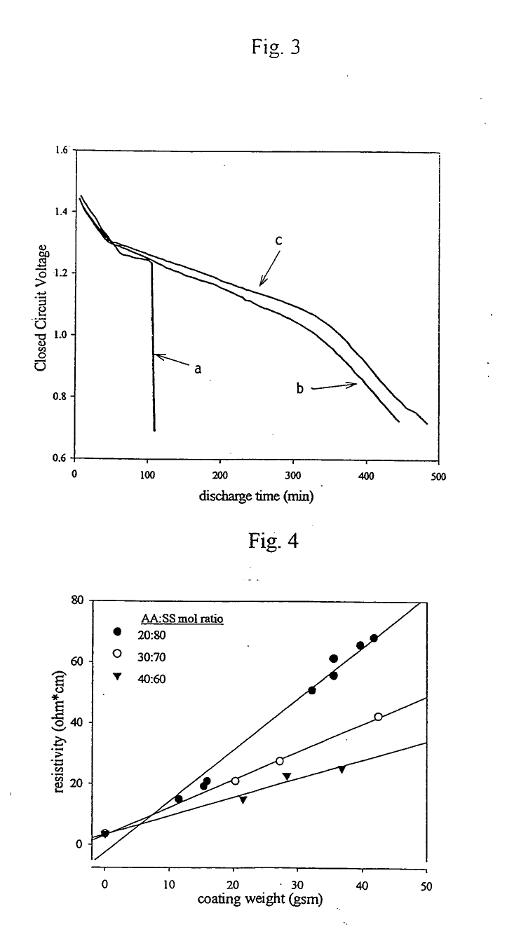

Shown in FIG. 3 is a plot of closed circuit voltage versus discharge time for three electrochemical cells that were discharged across a 3.9 ohm resistor for five minutes per day. Curve “a” represents a cell that contained a single wrap of uncoated separator. The cell developed an internal short through the separator and failed prematurely. Curve “b” represents a cell with a double wrap of uncoated separator. Curve “c” represents a cell of this invention that includes a single wrap of separator coated with a 30 gsm coating of a polymer comprising a 20:80 molar ratio of acrylic acid:styrene sulphonate. The battery represented by curve “c” did not develop an internal short and did provide service better than the conventional battery represented by curve “b”.

FIG. 4 demonstrates the relationship between the separator's coating weight and resistivity for three polymers with different ratios of acrylic acid to styrene sulphonate. The data demonstrates that the resistivity of the separator increases as the coating weight increases. The data also demonstrates that the resistivity of the separator decreases as the percentage of acrylic acid in the polymer increases.

The invention is illustrated by the following non-limiting examples. In the examples, the electrochemical cells used are of internationally recognised size AA, being the most common size electrochemical cell in use today. This has an internal volume available for ingredients of approximately 6.2 ml—the actual volume available may vary somewhat from this value depending upon the exact construction of the cell. However, the results reported here are fully scaleable to other cell sizes, making appropriate allowance, as is well known in the art, for cathode inner and outer diameter and cell height. For example, the present invention may be applied in the same way, using the same ratios of cathode to anode volume, to other well known standard or non-standard cell sizes, such as AAAA whose available internal volume is approximately 1.35 ml, AAA whose available internal volume is approximately 2.65 ml, C whose available internal volume is approximately 20.4 ml and D whose available internal volume is approximately 43.7 ml, and many other standard and non-standard cell sizes, including 9V batteries.

### EXAMPLE 1

### Preparation of Coated Separator

The separator paper used in these experiments was VLZ75, a conventional separator paper manufactured by Nippon Kodoshi Corporation of Japan.

Copolymers having the following ratios of acrylic acid (AA) to sodium styrenesulphonate (SS) were used:

AA:SS—
20:80
30:70
40:60

Each of these was separately dissolved in water to a solids content of 30% by weight. The resulting solutions had a viscosity of 20-25 Pa*s. These solutions were applied to VLZ75 paper using a roll coater and the coated papers were then steam drum dried. The rolls were covered with silicone paper to prevent sticking. The amounts of copolymer solution were adjusted so as to give a final coating weight of 20, 30, 40 or 50 gsm.

The resulting coated papers were all strong and flexible and the coatings showed no sign of flaking off (visual observation).

### EXAMPLE 2

### Absorption Tests for Separator Materials

The separator materials tested were as follows:
VLZ75
VLZ105
VLZ75 laminated with 25 μm thick cellophane
VLZ75 coated with 30 gsm of a 20:80 AA:SS copolymer

In the case of VLZ75 and VLZ105, uncoated, these were used as double layers, since that is required in conventional electrochemical cells. Only single layers of the coated papers were used.

Test cells were prepared containing a cathode and separator only in an AA size can. Each test cell was weighed. An excess of a 36% w/w aqueous solution of KOH (a typical electrochemical cell electrolyte) was added to each weighed can. The cans were then left for a set period, after which the excess electrolyte was thrown out and the cans were weighed. The difference between this weight and the initial weight is the amount of electrolyte soaked into the cathode and separator.

The period for which the electrolyte was allowed to soak into the cells was varied, and the results are reported as the weight absorbed after 20 minutes (which is, in most cases, the maximum weight of electrolyte absorbed) and the time required to reach this maximum absorption. The experiment was terminated after 30 minutes absorption, and so the result shown for VLZ75/cellophane shows the result after 30 minutes, at which time the maximum absorption had not been reached. The results are shown in the following Table 1.

TABLE 1
Physical measurements on separators

| | | | | Throw Out Test | |
|---|---|---|---|---|---|
| | | | | (Cathode + Separator) g | |
| | | | | Weight | |
| | | Thickness | | absorbed after | Time to |
| Separator | Layers | μm | gsm | 20 m (g) | max. (m) |
| VLZ75 | 2 | 114 | — | 1.32 | |
| VLZ105 | 2 | 160 | — | 1.59 | 1 m |
| VLZ75/ | 1 | 91 | — | 1.42 | 30 m |
| Cellophane | | | | | |
| VLZ75/20:80 | 1 | 67 | 30 | 1.28 | 2 m |
| AA:SS | | | | | |

Cellophane swells in aqueous KOH and takes over 30 minutes to absorb the solution fully. VLZ75/20:80 AA:SS soaks up the electrolyte almost as fast as VLZ105, which is recognised as one of the best separator papers. However, single layer separators soak up less than two layers.

### EXAMPLE 3

### Comparison of Performance of Separators in Electrochemical Cells

AA size electrochemical cells according to the present invention were assembled as follows:

Cathode pellets were made, each pellet weighing 2.84 g, having a height of 1.080 cm, an outer diameter of 1.345 cm and an inner diameter of 0.900 cm. The cathode mix used consisted of 94.76 weight % electrochemical manganese dioxide (EMD), 3.64 weight % graphite and 1.60 weight % of a 40% w/w aqueous solution of potassium hydroxide. The EMD was Toso Hellas GHU. The graphite was Superior Graphite Company's Thermopure GA17.

The pellets were then inserted into a standard AA size nickel plated steel can, 4 pellets per can. The can was pre-coated with either Timcal LB1099 or Acheson Colloid EB099. Since the pellets were a push fit, the inner diameter reduced to 0.885 cm. At this point, the separator was inserted into the can. In the case of the separator of the present invention and the separator comprising standard separator paper laminated to cellophane, a single layer was used with bottom and sides stuck together to make a tube, closed at one end (the bottom). Sufficient electrolyte (a 36% w/w aqueous solution of potassium hydroxide) was then added to just wet the cathode/can assembly and separator. For the cells of the present invention, this was 1.13 g.

7.10 g of an anode paste having the following composition was then inserted into the assembly, within the tube created from the separator.

Composition of Anode Paste:

| | | |
|---|---|---|
| Zinc | 70.100 | weight % |
| Carbopol 940 ™ | 0.370 | weight % |
| In(OH)₃ | 0.016 | weight % |
| ZnO | 0.036 | weight % |
| Electrolyte* | 29.480 | weight % |

*The electrolyte was a 36% w/w aqueous solution of potassium hydroxide.

2% of the weight of zinc used was as flake, the remainder was a powder. The zinc powder was an alloy that included small amounts of bismuth, indium and aluminum. The zinc flake was from Transmet Corporation of Columbus, Ohio U.S.A.

Finally, 0.35 g of a 36% w/w aqueous solution of potassium hydroxide was added, and the can was sealed in the usual way. The total cell internal volume was 6.33 ml and the volume of ingredients was 6.20 ml.

In the case of the control, cells using two layers of separator paper, these were assembled as described above, the layers of separator again being stuck together to make a similar tube, but, because the separator occupied more volume than that of the cells of the present invention or those using a cellophane-laminated separator, the following amounts and proportions differed from those described above (the corresponding amounts for the cells of the present invention are shown in parentheses):

| Anode paste weight | 6.80 g | (7.10 g) |
|---|---|---|
| Zinc content of anode paste | 73.200% | (70.100%) |
| Carbopol 940 ™ content of anode | 0.340% | (0.370%) |
| paste | | |
| In(OH)₂ content of anode paste | 0.017% | (0.016%) |
| ZnO content of anode paste | 0.036% | (0.035%) |
| Electrolyte content of anode paste | 26.410% | (29.480%) |
| Percent of zinc as flake | 0% | (2%) |

The assembled cells were then subjected to the following tests, using a standard test machine Model No. BT2043 from Arbin Instruments, 3206 Longmire Drive, College Station, Tex. 77845, USA, and software MITS97, also from Arbin Instruments.

3R9/1h/0V8

In this test, the electrochemical cells were discharged through a resistance of 3.9 Ω for 1 hour, then placed on an open circuit for 1 hour, and the cycle was repeated until an endpoint voltage of 0.8 V was reached. The results are reported in minutes (m).

1A/Cont./1V0

In this test, the electrochemical cells were discharged at a constant current of 1 A continuously, until an endpoint voltage of 1 V was reached. The results are reported in minutes (m).

The results are shown in the following Table 2.

TABLE 2
Performance comparison of separators

| | | | | | Discharge | |
|---|---|---|---|---|---|---|
| | | | | | Performance | |
| | Lay- | Thickness | | | 3R9/1 h/ | 1 A/Cont./ |
| Separator | ers | μm | gsm | Silicate | 0 V8 m | 1 V0 m |
| VLZ105 | 2 | 160 | — | YES | 489 | 47 |
| VLZ75/ | 1 | 91 | — | NO | 492 | 46 |
| Cellophane | | | | | | |
| VLZ75/ | 1 | 67 | 30 | NO | 504 | 52 |
| 20:80 | | | | | | |
| AA:SS | | | | | | |

It can be seen that the performance of the electrochemical cell containing the separator of the present invention is substantially better than that of the cells containing the known separators.

### EXAMPLE 4

### Comparison of Separators

AA size electrochemical cells were assembled as described in example 3.

The assembled cells were then subjected to the 1A/Cont./1V0 test. The results are shown in the following Table 3. In this and subsequent Tables, the ampere hours (Ah) are calculated on the assumption that the first electron reaction goes to completion but that the second electron reaction does not take place.

TABLE 3
Comparison of novel separator with conventional separator

| Cathode | | | | | | 1 A/Cont./1 V0 | | |
|---|---|---|---|---|---|---|---|---|
| Cathode | EMD:C | | KOH | | Anode | | Cathode | Anode |
| Ah | Ratio | ID mm | Initial | Sep. | Flake | Perf. m | Eff. % | Eff. % |
| 3.1 | 20 | 8.05 | 36 | 2 * VLZ105 | 0 | 44 | 23.7 | 17.8 |
| 3.1 | 20 | 8.05 | 36 | VLZ75/20:80 | 0 | 49 | 26.3 | 19.8 |
| 3.1 | 26 | 8.65 | 36 | 2 * VLZ105 | 0 | 46 | 24.7 | 18.6 |
| 3.1 | 26 | 8.65 | 36 | VLZ75/20:80 | 0 | 51 | 27.4 | 20.6 |
| 3.1 | 26 | 8.85 | 36 | 2 * VLZ105 | 0 | 46 | 24.7 | 18.6 |
| 3.1 | 26 | 8.85 | 36 | VLZ75/20:80 | 1 | 52 | 28.0 | 21.1 |
| 2.8 | 23 | 8.65 | 39 | 2 * VLZ105 | 0 | 52 | 31.0 | 23.3 |
| 2.8 | 23 | 8.65 | 39 | VLZ75/20:80 | 3 | 56 | 33.3 | 25.1 |
| 3.0 | 30 | 9.05 | 37 | 2 * VLZ105 | 0 | 44 | 24.4 | 18.4 |
| 3.0 | 30 | 9.05 | 37 | VLZ75/20:80 | 4 | 50 | 27.8 | 20.9 |
| 2.8 | 26 | 8.85 | 39 | 2 * VLZ105 | 1 | 53 | 31.5 | 23.7 |
| 2.8 | 26 | 8.85 | 39 | VLZ75/20:80 | 5 | 56 | 33.3 | 25.1 |
| 2.7 | 23 | 8.85 | 40 | 2 * VLZ105 | 3 | 55 | 34.0 | 25.6 |
| 2.7 | 23 | 8.85 | 40 | VLZ75/20:80 | 7 | 56 | 34.6 | 26.0 |
| 2.7 | 26 | 9.05 | 40 | 2 * VLZ105 | 5 | 55 | 34.0 | 25.6 |
| 2.7 | 26 | 9.05 | 40 | VLZ75/20:80 | 8 | 54 | 33.3 | 25.1 |
| 2.6 | 23 | 9.05 | 41 | 2 * VLZ105 | 6 | 55 | 35.3 | 26.5 |
| 2.6 | 23 | 9.05 | 41 | VLZ75/20:80 | 10 | 54 | 34.6 | 26.0 |

### EXAMPLE 5

To demonstrate the benefit of using a separator comprising a polymeric layer of acrylic acid and styrenesulphonate, as previously described, in a rechargeable cell comprising a compound containing silver in the cathode and zinc in the anode, two lots of AA size cells were made as follows and then evaluated on discharge tests to determine the separator's ability to stop migration of silver while also providing sufficient ionic conductivity to enable the cell to discharge at a high rate. The compositions of the cathodes, anodes and electrolyte used to manufacture the two lots of cells, designated herein as lot A and lot B, are shown below in table 4 wherein the proportions of each ingredient are given in weight percent. Lot A and lot B each contained monovalent silver oxide (Ag₂O) in the cathode. The separator in lot A was a single layer of cellophane. The separator in lot B was a single layer of a nonwoven substrate that had been coated on both sides with a 10 gram per square meter layer of a copolymer containing a 20:80 molar ratio of acrylic acid to styrenesulphonate. A transfer lamination process, as previously described, was used to apply a polymer film to both sides of the substrate.

TABLE 4

| | Lot A | Lot B |
|---|---|---|
| Cathode | | |
| EMD | 88.87 | 88.87 |
| Ag₂0 | 5.00 | 5.00 |
| graphite | 4.08 | 4.08 |
| coathylene | 0.45 | 0.45 |
| KOH (40 wt %) | 1.60 | 1.60 |
| Anode | | |
| Zinc powder | 62.47 | 62.47 |
| Zinc flakes | 5.43 | 5.43 |
| Carbopol 940 ™ | 0.40 | 0.40 |
| InOH₃ | 0.02 | 0.02 |
| ZnO | 0.03 | 0.03 |
| KOH | 31.65 | 31.65 |
| | (38.5 wt % KOH) | (38.5 wt % KOH) |
| Electrolyte | | |
| % KOH | 38.5 | 38.5 |
| First shot (g) | 1.48 | 1.48 |
| Separator | cellophane | Nonwoven |
| | | substrate coated on |
| | | both surfaces |

The cells in lots A and B contained 10.84 g of cathode and 6.84 g of anode. Unless otherwise noted, four cells from each lot were discharged on each of the following three service tests: (1) one watt continuous drain rate to a 1.0 volt cutoff; (2) one amp continuous drain rate to a 1.0 volt cutoff; and (3) each cell was repeatedly discharged at a one watt drain for seven seconds, then allowed to rest for three seconds, for one hour per day until the cell's voltage dropped below a 1.0 volt cutoff. The data in table 5 shows that the cells of this invention (lot B) that incorporated a separator coated with a copolymer made from acrylic acid and styrenesulphonate, as described above, provided better average service on two of the three service tests than did the cells that contained a conventional barrier layer (cellophane) as a separator.

TABLE 5

| Test | Lot A (minutes) | Lot B (minutes) |
|---|---|---|
| one watt continuous | 59 | 66 |
| one amp continuous | 58.23 | 56.5 |
| 1 watt drain for 7 seconds, | 78 | 87* |
| 3 seconds rest, 1 hour per | | |
| day | | |

*only one cell from lot B was available for this test due to cell construction problems that occurred during the assembly of the cells.

### EXAMPLE 6

To demonstrate the benefit of using a separator comprising a polymeric layer of acrylic acid and styrenesulphonate, as previously described, in a rechargeable zinc air cell, a 9 cm by 13 cm free standing separator film, made from a copolymer having a 40:60 ratio of acrylic acid to styrenesulphonate, was inserted into a zinc air battery that was repeatedly cycled by discharging the cell at a 12.5 watt constant power discharge and then charging it at 2.15 volts. The zinc air battery utilized molecular oxygen from the environment to react with the zinc in the cell to produce a useful current. The cell was successfully cycled 32 times before the test was terminated. In comparison, identical test cells that contained Celgard 3401, a commercially available microporous barrier separator, typically stopped functioning at 20 charge/discharge cycles due to internal shorts through the separator. This data demonstrates that a separator made from a polymerized film of acrylic acid and styrenesulphonate can successfully deter the creation of electrical shorts when used in a rechargeable zinc air cell.

In addition to using the separator described above in zinc-MnO₂, silver-zinc and zinc-air cells, other chemical systems in which a separator containing a polymerized film of acrylic acid and styrenesulphonate would be useful include nickel-metal hydride, nickel-cadmium, zinc-nickel oxyhydroxide, zinc-copper oxide and zinc-mercuric oxide.

1. An electrochemical cell comprising a first electrode and a second electrode separated from one another by a separator, wherein said first electrode comprises a compound containing silver and said separator comprises a copolymer of an ethylenically unsaturated carboxylic acid of formula I or salt thereof 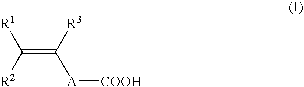
and an aromatic compound of formula II 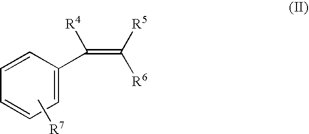
wherein R¹, R², R³, R⁴, R⁵ and R⁶ are selected from the group consisting of a hydrogen atom, an alkyl group having from 1 to 10 carbon atoms, and an aryl group, R⁷ is selected from the group consisting of a sulphonate, a carboxylate group and an associated balancing cation, and A is selected from the group consisting of a direct bond and an alkyl group having up to 8 atoms.

2. The electrochemical cell of claim 1, wherein said first electrode comprises silver oxide.

3. The electrochemical cell of claim 2, wherein said first electrode comprises a mixture of silver oxide and manganese dioxide.

4. The electrochemical cell of claim 1, wherein said separator comprises a porous substrate having a coating of said copolymer.

5. The electrochemical cell of claim 4, wherein said separator comprises a porous substrate having a first surface and a second surface.

6. The electrochemical cell of claim 5, wherein said separator is coated on only one surface with said copolymer.

7. The electrochemical cell of claim 4, wherein said separator is coated on both surfaces with said copolymer.

8. The electrochemical cell of claim 4, wherein said coating is a polymer film secured to said substrate by a transfer lamination process.

9. The electrochemical cell of claim 4, wherein said coating is a polymer film secured to said substrate by a transfer lamination process.

10. The electrochemical cell of claim 1, wherein said second electrode comprises zinc.

11. The electrochemical cell of claim 7, wherein said second electrode comprises zinc powder.

12. The electrochemical cell of claim 1 further comprises a caustic, aqueous based electrolyte.

13. The electrochemical cell of claim 11, wherein said electrolyte comprises at least 30 percent by weight potassium hydroxide.

14. The electrochemical cell of claim 1, in which R¹, R², R³, R⁴, R⁵ and R⁶ all represent hydrogen atoms.

15. The electrochemical cell of claim 1, wherein the compound of formula (I) has the formula (Ia):

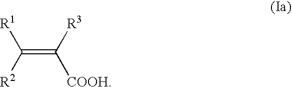

16. The electrochemical cell of claim 14, wherein, R¹, R² and R³ are selected from the group consisting of a hydrogen atom, an alkyl group having from 1 to 10 carbon atoms, and an aryl group.

17. The electrochemical cell of claim 14, wherein, R¹, R² and R³ all represent hydrogen atoms.

18. The electrochemical cell of claim 14, wherein, said compound of formula (Ia) is selected from the group consisting of acrylic acid or methacrylic acid.

19. The electrochemical cell of claim 17, wherein, said compound of formula (Ia) is acrylic acid.

20. The electrochemical cell of claim 1, wherein said compound of formula (II) is a styrenesulphonate.

21. The electrochemical cell of claim 19, wherein said compound of formula (II) is sodium styrenesulphonate.

22. The electrochemical cell of claim 1, wherein the molar ratio of said compound or compounds of formula (I) to said compound or compounds of formula (II) is from 20:80 to 60:40.

23. The electrochemical cell of claim 1, wherein said separator is a coating of said copolymer on said first electrode or said second electrode.

24. The electrochemical cell of claim 5, wherein said coating of said copolymer on said substrate extends only partway through the thickness of the substrate.

25. The electrochemical cell of claim 4, wherein the coating weight of said copolymer is between 10 g/m² and 60 g/m².

26. The electrochemical cell of claim 24, wherein the coating weight of said polymer is between 20 g/m² and 50 g/m².

27. The electrochemical cell of claim 25, wherein the coating weight of said polymer is between 30 g/m² and 40 g/m².

28. An electrochemical cell comprising a first electrode and a second electrode separated from one another by a separator, wherein said first electrode's electrochemically active material is molecular oxygen, said second electrode comprises zinc and said separator comprises a copolymer of an ethylenically unsaturated carboxylic acid of formula I or salt thereof 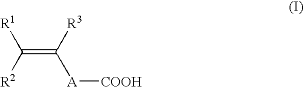
and an aromatic compound of formula II 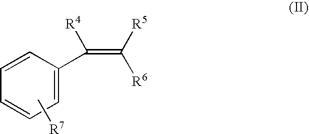
wherein R¹, R², R³, R⁴, R⁵ and R⁶ are selected from the group consisting of a hydrogen atom, an alkyl group having from 1 to 10 carbon atoms, and an aryl group, R⁷ is selected from the group consisting of a sulphonate, a carboxylate group and an associated balancing cation, and A is selected from the group consisting of a direct bond and an alkyl group having up to 8 atoms.

29. The electrochemical cell of claim 27 wherein said cell is rechargeable.

30. The electrochemical cell of claim 27 wherein said molecular oxygen is obtained from the environment surrounding said cell.

31. The electrochemical cell of claim 29 wherein said cell further comprises a container having a hole therethrough, said molecular oxygen flowing through said hole as it moves from the environment surrounding the cell to the first electrode.
